(19) United States
(12) Patent Application Publication
(10) Pub. No.: US 2010/0070965 A1
(43) Pub. Date: Mar. 18, 2010

(54) Software Update Service with Compatibility Checking

(76) Inventors: Justin Britten, Austin, TX (US); Dustin J. Mihalik, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/210,265

(22) Filed: Sep. 15, 2008

(51) Int. Cl. G06F 9/44

(52) U.S. Cl. 717/173

(57) ABSTRACT

System and method for updating software over a network. A computer system is scanned to determine installed software, including determining a unique code and version information for each of one or more programs. A list of the installed software, including the determined unique code and version information for each program, is generated in response to the scanning, and sent to a server computer system over the network. Information is received describing updates for at least one of the programs from the server computer system over the network. The computer system and the information describing updates are analyzed, and one or more updates that are safe to install on the computer system are determined based on the analyzing. The one or more updates are displayed on a display of the computer system, and at least one update of the one or more updates is installed on the computer system.

### FIELD OF THE INVENTION

The present invention relates generally to the field of software updating, and more particularly to a system and method for updating software over a network with compatibility checking.

### DESCRIPTION OF THE RELATED ART

Network based software updating has proven to be an effective way to insure that software on remote systems is current. Prior art approaches generally either simply provide update packages in response to user input requesting a download of specific updates, or provide updates based on versions of the software currently installed on the user's system. However, there may be other factors regarding the user's system that may impact what software updates should be installed.

Thus, improved systems and methods are desired for updating software over a network.

### SUMMARY OF THE INVENTION

Various embodiments of a system and method for updating software over a network are described. First, a computer system (e.g., a client computer system) may be scanned to determine installed software, including determining a unique code and version information for each of one or more programs (installed on the computer system).

A list of the installed software may be generated in response to the scanning. In some embodiments, the list includes the determined unique code and version information for each of the one or more programs. In some embodiments, the list may not include the version information specifically, but this version information may be determinable or derivable from the unique codes. In yet another embodiment the unique code may include the version information.

The list may be sent to a server computer system over a network. Note that this list may be sent using any network transmission protocols as desired, e.g., HTTP, FTP, email, wireless, etc. In some ways, this list may be considered to be a query by the client to the server for available updates. Thus, from this point of view, the server receives one large query from the client. This query for updates may include all software for some specified domain installed on the client computer, e.g., all National Instruments Corporation software, etc.

Information describing updates for at least one of the one or more programs may be received from the server computer system over the network. In one embodiment, the information describing updates may be included in an XML (extensible Markup Language) file, although any other types of files or formats may be used as desired. The information describing updates may include at least one location from where the updates can be downloaded. For example, the information may include path information, including, for example, a machine or network address specification such as a URL, FTP address, etc. In one embodiment, the information describing updates include the file size of each update and/or a checksum for each update. More generally, the information may include data that may be used to transmit and/or verify the updates. In some embodiments, the information may also include the type of update, e.g., updates intended to address software defects may be referred to as “critical updates”, those making non-critical improvements may be denoted as “maintenance updates”, etc., although it should be noted that any (or none) denotations may be used as desired.

The computer system and the information describing updates may be analyzed. In other words, software executing on the computer system may analyze the information sent from the server computer system as well as the computer system itself. For example, in some embodiments, the information describing updates includes one or more conditions specifying safety requirements of the one or more updates. Analyzing the computer system and the information describing updates may thus include analyzing the one or more conditions. In one embodiment, the conditions for each update may be included in an installer for the update, e.g., by the developer of the update/installer. These conditions (and possibly other portions of the information) may be extracted from the installer (based on the list) for sending to the (client) computer system.

As noted above, in some embodiments, the server receives one large query from the client (i.e., the list mentioned above). In these embodiments, the server may break or parse this query into independent queries—one for each product/version pair. These independent queries may then be sent to an update database, and the result of these queries written to a single file, e.g., an XML file, for later transmission to the client in response to the client's query, as indicated above. The server may then make independent queries to the update database, and the response of each database query may be written to a file, e.g., an XML file. Note that this XML file is not for display on the client system, and may include supporting information for each update, including, e.g., location on an FTP server (or other device), description, file size, checksum, and/or conditions to be evaluated prior to displaying the update to the customer/user, among others. As indicated above, some of this supporting information may be provided by the installer for the update. For example, the server may extract a file, e.g., updateInfo.xml, from the installer, parse the file, and write some or all of the supporting information, e.g., the conditions to be evaluated prior to displaying the update, to the update database (or some other storage means). Note that this file (e.g., updateInfo.xml) is distinct from the file (also possibly an XML file) generated by the server based on the queries.

As noted above, the computer system itself may also be analyzed. For example, analyzing the computer system and the one or more conditions may include analyzing one or more of: the operating system (OS) of the computer system, versions of other software installed on the computer system, and/or hardware installed in or coupled to the computer system. Thus, the method may examine or analyze the (safety) conditions in light of the current state of the computer system to determine whether each update is safe to install.

One or more updates may then be determined that are safe to install on the computer system based on the analyzing. In other words, based on the above analysis, the method may determine those updates that satisfy the conditions (for that update), i.e., that are compatible with the current computer system configuration.

The one or more updates may be displayed on a display of the computer system, e.g., for viewing by a user of the computer system. Thus, the computer system shows each update to the customer only if all conditions for that update are satisfied. In one embodiment, the method may also include displaying information regarding updates that were determined to be unsafe, e.g., along with the respective conditions that were not satisfied. Further details regarding the display of updates for the computer system are provided below.

Finally, at least one update of the one or more updates may be installed on the computer system. Note that the installation of the updates may be performed in any of various ways. For example, in one embodiment installing at least one update may include automatically installing the one or more updates without direct user input specifying updates to install, e.g., the (safe) updates may be installed without any input from the user at all, or may be installed in response to user input indicating that the automatic installation of safe updates is to proceed, e.g., by the user clicking an “ok” button, etc. Thus, in some embodiments, the method may include receiving user input confirming the one or more updates, and the installing at least one update may include installing the one or more updates in response to the user input confirming the one or more updates.

In other embodiments, the user may specify which updates to install. In other words, the method may include receiving user input indicating the at least one update, and installing the at least one update may be performed in response to receiving the user input indicating the at least one update. For example, the user may (double) click on each update to confirm installation of the update, may invoke a menu with installation options and select an “install” option to invoke the installation, may check boxes displayed by each update, etc. Note that these various means for invoking or confirming the update installations are meant to be exemplary only, and are not intended to limit the approaches to any particular form, function, or appearance.

As noted above, in some embodiments, the information describing updates includes at least one location from where the updates can be downloaded, e.g., path information, including, e.g., a machine or network address specification. Installing the at least one update of the one or more updates on the computer system may thus include downloading the at least one update from the at least one location. In one embodiment, downloading the at least one update from the at least one location may be performed via HTTP (Hypertext Transfer Protocol), although any other protocol may be used as desired. Note that in various embodiments, the location for downloading the updates may be anywhere on the network. For example, in one embodiment the location may be on the server computer itself. In another embodiment, the location may be one or more third computer systems, e.g., an FTP server. Note that in one embodiment, while the files may be stored on the same servers that host FTP, they may be downloaded via HTTP. Of course in other embodiments, any network accessible device capable of storing and providing the updates for download may be used as desired, and may be transferred via any protocols desired.

The above is described from the client's perspective. The below is from the server's perspective.

First, a list of the installed software may be received from a client computer system over a network, e.g., including a unique code and possibly version information for each of one or more programs installed on the (client) computer system. In some embodiments, the list may not include the version information specifically, but this version information may be determinable or derivable from the unique codes. In yet another embodiment the unique code may include the version information. This list may be received over the network using any network transmission protocols as desired, e.g., HTTP, FTP, email, wireless, etc. In some ways, this list may be considered to be a query by the client to the server for available updates. Thus, from this point of view, one large query regarding updates may be received from the client. This query for updates may include identification of all software for some specified domain installed on the client computer, e.g., all National Instruments Corporation software, etc.

An update database that stores information regarding the software updates for each of the one or more programs may be queried. As noted above, in some embodiments, the server receives one large query from the client (i.e., the above list). In these embodiments, the server may break or parse this query into independent queries—one for each product/version pair. These independent queries may then be sent to the update database.

Information describing updates for at least one of the one or more program may be determined based on the querying. As noted above, in some embodiments, this information may be generated in response to the server making queries to the update database, and may include the responses of each database query, as well as supporting information for each update, including, e.g., location on an FTP server (or other device), description, file size, checksum, and/or conditions to be evaluated prior to displaying the update to the customer/user. The information may be written to a file for transmission to the client system, e.g., an XML file (which is not for display on the client system).

In some embodiments, the information describing updates may include one or more conditions specifying safety requirements of the one or more updates, where the conditions are useable by the client computer system to determine which of the updates are safe to install on the computer system. The conditions may be specified by a developer, and may be included in the installer for the update (by the developer). Thus, for example, in one embodiment, the server may receive and store an update installer that includes the one or more conditions, and may extract the one or more conditions from the installer, storing the one or more conditions in the database. Subsequently, the server may retrieve the one or more conditions for inclusion in the information describing updates. More specifically, the server may analyze the list of installed software received from the client computer system, and determine respective database queries for each of the one or more programs installed on the client computer system based on this analyzing. As indicated above, querying the database of software updates regarding each of the one or more programs may include independently submitting each of the respective database queries to the database. Of course, in other embodiments, other means for acquiring the conditions may be used as desired.

The information describing the updates for at least one of the one or more programs may be sent from the server computer system to the client computer system over the network. As noted above, in a preferred embodiment, the information describing updates may be included in an XML (eXtensible Markup Language) file, although any other types of files or formats may be used as desired. As described above, the information describing the updates may be useable by the client system to update (at least one of) the one or more programs installed on the client computer system. The response of the client system to this information is described above.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system configured to implement embodiments of the present invention;

FIG. 1B illustrates a network system comprising two or more computer systems configured to implement embodiments of the present invention;

FIG. 2 is an exemplary block diagram of the computer systems of FIGS. 1A and 1B;

FIG. 3 illustrates a system for updating software over a network, according to one embodiment;

FIG. 4 is a flowchart diagram illustrating one embodiment of a method for updating software over a network from the client side, according to one embodiment;

FIG. 5 is a flowchart diagram illustrating one embodiment of a method for updating software over a network from the server side, according to one embodiment;

FIG. 6 illustrates an initial screen of a client-side graphical user interface (GUI) for updating software over a network, according to one embodiment;

FIG. 7 illustrates a screenshot of a client-side GUI for indicating progress with regards to updating software over a network, according to one embodiment; and

FIG. 8 illustrates a screenshot of a client-side GUI displaying updates for which all conditions for safe installation are satisfied, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium that conveys signals such as electrical, electromagnetic, or digital signals, such as a bus, network and/or other physical transmission medium.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Graphical Program—a plurality of interconnected nodes that visually represent the functionality of the program, where the program is executable or interpretable to perform the functionality.

Hardware Configuration Program—a program, e.g., a netlist or bit file, that can be used to program or configure a programmable hardware element.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Graphical User Interface Element—an element of a graphical user interface, such as for providing input or displaying output. Exemplary graphical user interface elements comprise input controls and output indicators

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

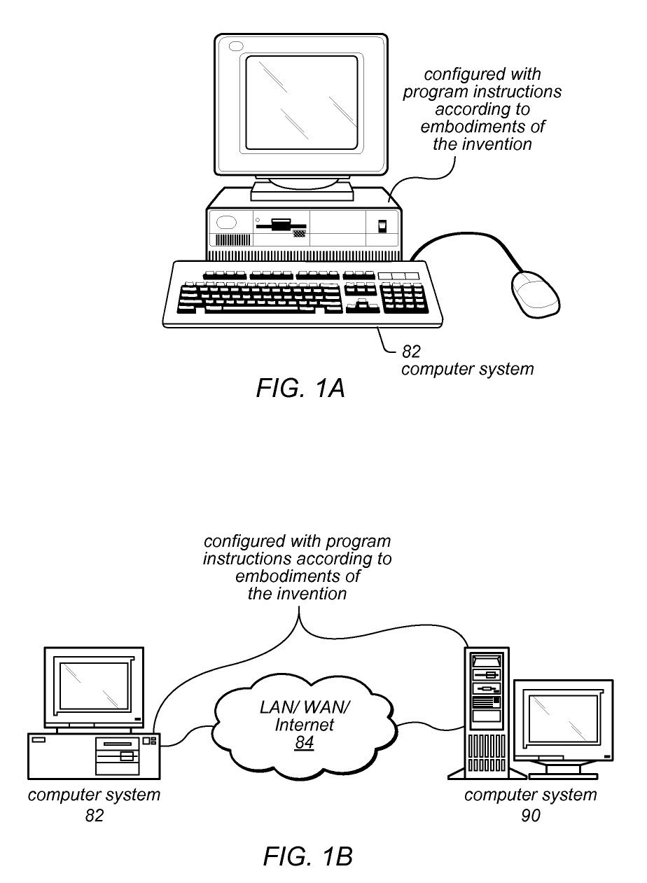

### FIG. 1A—Computer System

FIG. 1A illustrates a computer system 82 configured to execute program instructions implementing embodiments of the present invention. As shown in FIG. 1A, the computer system 82 may include a display device operable to display an interface, such as a graphical user interface (GUI), facilitating interactions between a user and software executing on the computer system 82. For example, the graphical user interface may comprise any type of graphical user interface, e.g., depending on the computing platform.

The computer system 82 may include a memory medium(s) on which one or more computer programs or software components according to one embodiment of the present invention may be stored. For example, the memory medium may store one or more programs, e.g., text-based programs or graphical programs, which are executable to perform embodiments of the methods described herein. For example, in one embodiment, the computer system 82 may operate as a client system, and may thus store client-side software implementing client functionality of a software update service. Alternatively, the computer system 82 may operate as a server system, and may thus store server-side software implementing server functionality of the software update service. Thus, embodiments of the present invention may be implemented by software, e.g., program instructions.

Also, the memory medium may store a programming development environment application used to create and/or execute such programs. The memory medium may also store operating system software, as well as other software for operation of the computer system. Various embodiments further include receiving or storing instructions and/or data implemented in accordance with the foregoing description upon a carrier medium. Thus, in some embodiments, the methods disclosed herein may be performed by software, i.e., program instructions, e.g., executed by one or more computer systems.

Note that the software update service described herein may be used for any type of software desire, including, but not limited to, software related to manufacturing processes, scientific processes, financial or securities-related processes, automation processes, simulation processes, petrochemical exploration and/or production processes, and so forth, among others.

Note also that as used herein, the terms “process” and “system” may be used interchangeably. Thus, software related to a process may be interpreted as being related to a system for that process, and vice versa.

### FIG. 1B—Computer Network

FIG. 1B illustrates a networked computer system configured to implement embodiments of the present invention, including a first computer system 82 that is coupled to a second computer system 90. The computer system 82 may be connected through a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may implement embodiments of the present invention in a distributed fashion. For example, as indicated above, computer 82 may execute client software that performs a first portion (client software) of the software update service, and so computer system 90 may execute server software that performs a second portion (server software) of the software service, as will be described below in more detail.

In some embodiments, the program development environment may be the LabVIEW graphical program development environment provided by National Instruments Corporation, and the programs described herein may be graphical programs developed in the “G” graphical programming language also provided by National Instruments Corporation. For example, as described above in the glossary of terms, a graphical program comprises a plurality of interconnected nodes or icons, wherein the plurality of interconnected nodes or icons visually indicate functionality of the program. These interconnected nodes form a block diagram. In some cases, the graphical program may also include a user interface portion, referred to as a front panel, which includes one or more controls or indicators for human interaction with the program. Further details regarding graphical programming may be found in U.S. Pat. No. 4,914,568 titled “Graphical System for Modeling a Process and Associated Method”, U.S. Pat. No. 5,481,741 titled “Method and Apparatus for Providing Attribute Nodes in a Graphical Data Flow Environment”, U.S. Pat. No. 6,173,438 titled “Embedded Graphical Programming System”, U.S. Pat. No. 6,219,628 titled “System and Method for Configuring an Instrument to Perform Measurement Functions Utilizing Conversion of Graphical Programs into Hardware Implementations”, and U.S. Patent Application Publication No. 20010020291 (Ser. No. 09/745,023) titled “System and Method for Programmatically Generating a Graphical Program in Response to Program Information”, each of which was incorporated by reference above.

Note that in embodiments where the computer system 92 is a server computer, the computer may or may not have a dedicated display device. Moreover, in some embodiments, the computer may be a blade server, e.g., in a rack of other servers.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, characterization or analysis of a product, process, or phenomenon, etc. Exemplary test applications where the program may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including updating software for any of various types of devices such as multimedia devices, video devices, audio devices, telephony devices, Internet devices, etc., as well as general purpose software applications such as word processing, spreadsheets, network control, network monitoring and/or management, financial applications, games, etc.

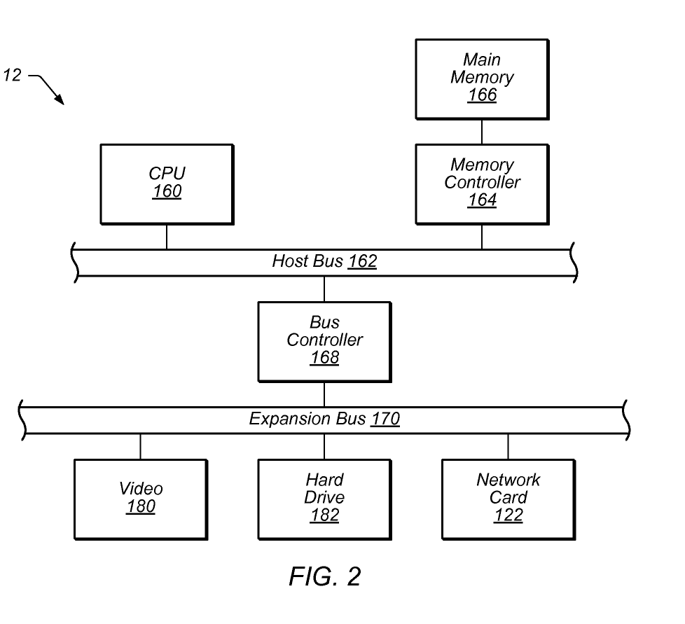

### FIG. 2—Computer System Block Diagram

FIG. 2 is a block diagram representing one embodiment of the computer system 82 and/or 90 illustrated in FIG. 1, or computer system 82 shown in FIG. 2A or 2B. It is noted that any type of computer system configuration or architecture can be used as desired, and FIG. 2 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store program instructions according to various embodiments of the invention, e.g., client and/or server programs for updating software over a network, as will be described in detail below. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 may include slots for any of various devices as desired. As shown, in this embodiment, the computer 82 further comprises a video display subsystem 180 and hard drive 182 coupled to the expansion bus 170.

### Overview

In a preferred embodiment, the update service disclosed herein performs most (or all) of the decisions regarding which candidate software updates to show to the user on the client-side rather than the server-side, in contrast with prior art approaches. A list of software may be received from a server that has more recent versions of software than those installed on the client, and the update service performs various checks to determine if this software should be (or can safely be) installed on the client system. The installer developer can specify certain conditions that need to be met in order for the updates to be safe, i.e., compatible with the client system as currently configured, and thus for the update service to display the candidate software updates, e.g., the conditions may specify necessary aspects of the current OS and versions of other software installed on the client system. For example, a condition may specify: “Labview Real-Time 8.6 will only install on Windows XP and only if LabVIEW 8.6 is installed.”

In one embodiment, the update service may display any updates deemed to be safe to install. In an alternative embodiment, the update service may then not show updates to the user if any of the specified conditions fail. These conditions to be evaluated may be stored in a file, e.g., an XML file, that accompanies the update, and may be evaluated on the client by querying a local database. This client-side database may accept queries, such as “Is LabVIEW 8.6 installed?” or “What version of LabVIEW is installed?”, and by analyzing the client system, e.g., by examining a registry or file system of the client computer system, may respond appropriately, e.g., “Yes” or “8.6”, respectively. The update service may have means of updating this database if necessary. The update service may then display safe software updates to the user of the client system, i.e., recommended updates for which the conditions are satisfied, after which the (safe) software updates may be downloaded and installed to the client system, e.g., in response to user input.

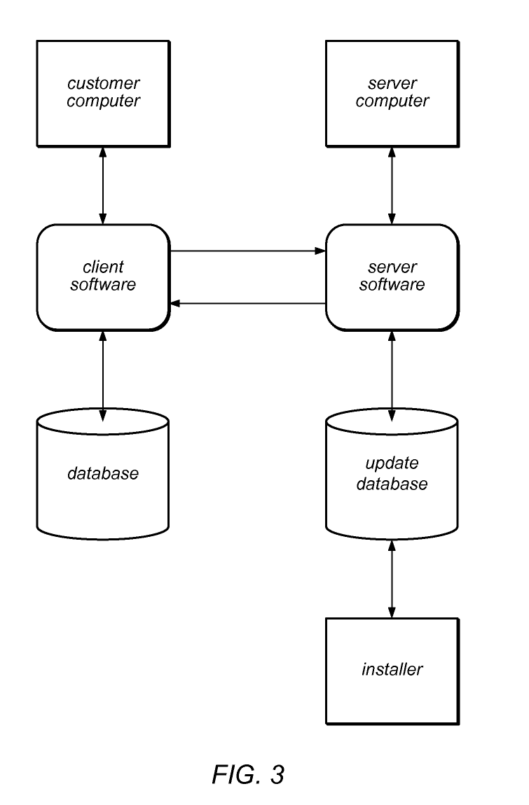

### FIG. 3—Exemplary System

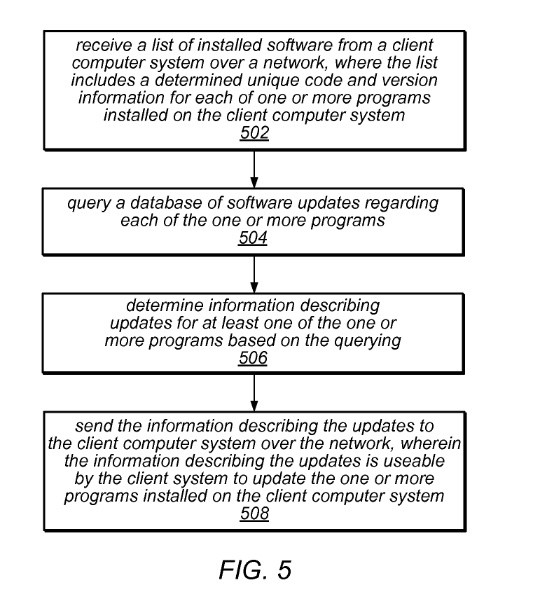

FIG. 5 illustrates an exemplary system, according to one embodiment. This FIG. 5 shows, a customer computer, i.e., a client computer system, e.g., computer system 82, executes client software, and includes or has access to a local database whereby conditions for each update may be evaluated. The client computer/software is communicatively coupled to server software, e.g., executing on a server computer system, e.g., computer system 90, which has access to an update database, i.e., a database of information regarding software updates, and possibly the updates themselves, where the information includes conditions for safe installation of the updates, etc., which may be extracted from the installer for each update, as indicated in FIG. 3. Note that the system shown is meant to be exemplary only, and that other architectures may also be used as desired.

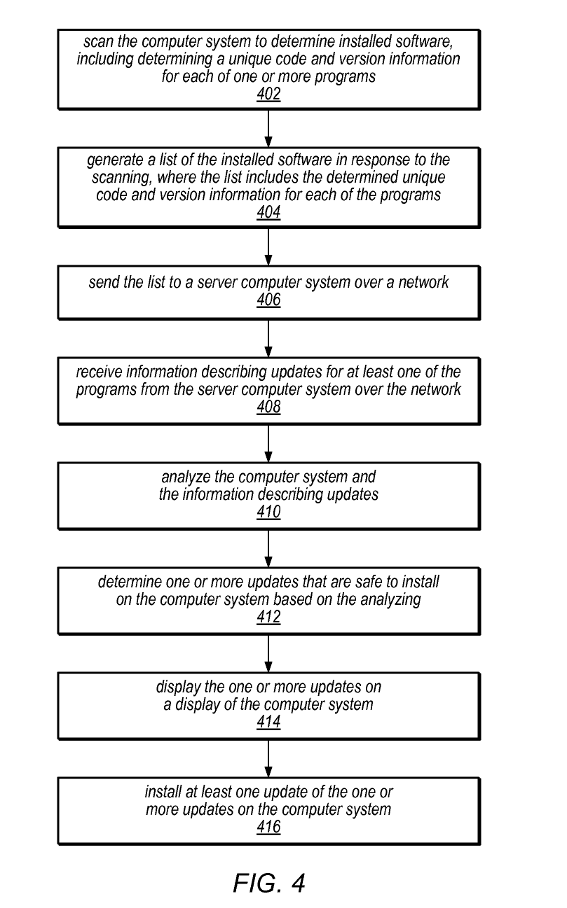

### FIG. 4—Flowchart of a Method for Updating Software Over a Network

FIG. 4 illustrates one embodiment of a computer-implemented method for updating software over a network. The method shown in FIG. 4 may be used in conjunction with any of the computer systems shown in the above figures, among other devices. Note that the method of FIG. 4 is from the perspective of a client system. A server side method is described below with reference to FIG. 5. In various embodiments, some of the method elements shown may be performed concurrently, in a different order than shown, or may be omitted. Additional method elements may also be performed as desired. As shown, this method may operate as follows.

First, in 402, a computer system may be scanned to determine installed software, including determining a unique code and version information for each of one or more programs (installed on the computer system). For example, the computer system may be a client computer system, e.g., computer system 82 coupled to a server 90.

In 404, a list of the installed software may be generated in response to the scanning. In preferred embodiments, the list includes the determined unique code and version information for each of the one or more programs. In some embodiments, the list may not include the version information specifically, but this version information may be determinable or derivable from the unique codes. In yet another embodiment the unique code may include the version information.

In one exemplary case, the user may be concerned with possible updates to LabVIEW Real-Time 8.6 (provided by National Instruments Corporation), which, for example, may be identified as {AAA-BBB-CCC}, 860, where “{AAA-BBB-CCC}” is the unique code for this software program, and “860” denotes version 8.6, although any other means of identification may be used as desired.

In 406, the list may be sent to a server computer system over a network, e.g., to computer system 90. Note that this list may be sent using any network transmission protocols as desired, e.g., HTTP, FTP, email, wireless, etc. In some ways, this list may be considered to be a query by the client to the server for available updates. Thus, from this point of view, the server receives one large query from the client. This query for updates includes all software for some specified domain installed on the client computer, e.g., all National Instruments Corporation software, etc.

In 408, information describing updates for at least one of the one or more programs may be received from the server computer system over the network. In a preferred embodiment, the information describing updates may be included in an XML (eXtensible Markup Language) file, although any other types of files or formats may be used as desired. In some embodiments, the information describing updates may include at least one location from where the updates can be downloaded. For example, the information may include path information, including, for example, a machine or network address specification such as a URL, FTP address, etc. In one embodiment, the information describing updates include the file size of each update and/or a checksum for each update. More generally, the information may include data that may be used to transmit and/or verify the updates. In some embodiments, the information may also include the type of update, e.g., updates intended to address software defects may be referred to as “critical updates”, those making non-critical improvements may be denoted as “maintenance updates”, etc., although it should be noted that any (or none) denotations may be used as desired.

Thus, following the above LabVIEW example, the server responded (via the XML file) that LabVIEW Real-Time 8.6.1 exists, and is an update to the installed LabVIEW Real-Time 8.6. The XML file response from the server also notes that the LabVIEW Real_Time 8.6.1 update has a condition that LabVIEW 8.6.1 must be installed (LV861DETECTED). The client now needs to evaluate whether or not this condition is satisfied before showing the update to the customer, as explained below.

In 410, the computer system and the information describing updates may be analyzed. In other words, software executing on the computer system may analyze the information sent from the server computer system as well as the computer system itself. For example, in preferred embodiments, the information describing updates includes one or more conditions specifying safety requirements of the one or more updates. Analyzing the computer system and the information describing updates may thus include analyzing the one or more conditions.

In one embodiment, the conditions for each update may be included in an installer for the update, e.g., by the developer of the update/installer. These conditions (and possibly other portions of the information) may be extracted from the installer (based on the list of 406) for sending to the (client) computer system. For example, following the above example regarding LabVIEW Real-Time, an installer for the LabVIEW Real-Time 8.6 update (provided by National Instruments Corporation) may contain the condition “LV86DETECTED” to represent that LabVIEW 8.6 must be detected in order for this update to be safe (and thus, to be shown to the customer, i.e., the user of the client computer system). When the final installer executable is built, these conditions may be written to a file, e.g., an XML file, which may then be included in the installer. The file, e.g., updateInfo.xml, may be written automatically during the installer build process, and may be placed alongside all of the other files, which together make up the installer distribution for LabVIEW Real-Time 8.6. This file may thus contain the condition “LV86DETECTED”. The update installer may then be uploaded to server, e.g., by a developer or other employee of the development entity, for serving this file to customers.

As noted above, in some embodiments, the server receives one large query from the client (i.e., the list of 404 above). In these embodiments, the server may break or parse this query into independent queries—one for each product/version pair. These independent queries may then be sent to an update database, and the result of these queries written to a single file, e.g., an XML file, for later transmission to the client in response to the client's query, as indicated above. For example, following the LabVIEW Real-Time 8.6 example, the database entry for the LabVIEW Real-Time 8.6 update may now have stored in it the condition that LabVIEW 8.6 must be installed (LV86DETECTED) for this update to be safe. The server may then make independent queries to the update database, and the response of each database query may be written to a file, e.g., an XML file. Note that this XML file is not for display on the client system, and may include supporting information for each update, including, e.g., location on an FTP server (or other device), description, file size, checksum, and/or conditions to be evaluated prior to displaying the update to the customer/user, among others. As noted above, some of this supporting information may be provided by the installer for the update. For example, the server may extract a file, e.g., updateInfo.xml, from the installer, parse the file, and write some or all of the supporting information, e.g., the conditions to be evaluated prior to displaying the update, to the update database (or some other storage means). Note that this file (e.g., updateInfo.xml) is distinct from the file (also possibly an XML file) generated by the server based on the queries.

As mentioned above, the computer system itself may also be analyzed. For example, analyzing the computer system and the one or more conditions may include analyzing one or more of: the operating system (OS) of the computer system, versions of other software installed on the computer system, and/or hardware installed in or coupled to the computer system. Thus, the method may examine or analyze the (safety) conditions in light of the current state of the computer system to determine whether each update is safe to install.

In one embodiment, the method may include determining the current state of the computer system. For example, analyzing the computer system and the one or more conditions may include querying a local database regarding software on the client system, and the database examining a registry or file system of the client computer system and responding to the query accordingly. In some embodiments, querying a local database regarding software on the client system includes submitting the one or more conditions to the local database, and where the database responding to the query includes the database indicating whether the one or more conditions are satisfied. Thus, the database may be capable of evaluating the conditions in view of the state of the computer system. In one embodiment, e.g., again, following the LabVIEW example in a Microsoft Windows™ context, the local database may be or include an API (application programming interface) for a DLL which can evaluate the Windows Registry and file system to determine whether or not a given piece of software is installed, and can respond to queries such as, “Is LabVIEW 8.6.1 installed?” or “What version of LabVIEW is installed?”. Note that in other embodiments, the database may not be local, but may be accessible over the network. The computer system (client) may thus send conditions to be evaluated to the database, and the database may return true or false to condition queries, although it should be noted that this is but an exemplary description of the manner in which the computer system evaluates the conditions, and it not intended to limit the evaluation to any particular form or function. In one embodiment, the computer system (client) may also ensure that the local database is up-to-date. If not up-to-date, the computer system may download the most recent database, e.g., from the server, e.g., using an independent process. Alternatively or additionally, the current state of the computer system may be maintained, e.g., in one or more files, and the method may simply examine the file(s) to analyze the computer system.

In 412, one or more updates may be determined that are safe to install on the computer system based on the analyzing of 410. In other words, based on the analysis of 410, the method may determine those updates that satisfy the conditions (for that update), i.e., that are compatible with the current computer system configuration.

In 414, the one or more updates may be displayed on a display of the computer system, e.g., for viewing by a user of the computer system. Thus, the computer system shows each update to the customer only if all conditions for that update are satisfied. In one embodiment, the method may also include displaying information regarding updates that were determined to be unsafe, e.g., along with the respective conditions that were not satisfied. Further details regarding the display of updates for the computer system are provided below.

Finally, in 416, at least one update of the one or more updates may be installed on the computer system. Note that the installation of the updates may be performed in any of various ways. For example, in one embodiment installing at least one update may include automatically installing the one or more updates without direct user input specifying updates to install, e.g., the (safe) updates may be installed without any input from the user at all, or may be installed in response to user input indicating that the automatic installation of safe updates is to proceed, e.g., by the user clicking an “ok” button, etc. Thus, in some embodiments, the method may include receiving user input confirming the one or more updates, and the installing at least one update may include installing the one or more updates in response to the user input confirming the one or more updates.

In other embodiments, the user may specify which updates to install. In other words, the method may include receiving user input indicating the at least one update, and installing the at least one update may be performed in response to receiving the user input indicating the at least one update. For example, the user may (double) click on each update to confirm installation of the update, may invoke a menu with installation options and select an “install” option to invoke the installation, may check boxes displayed by each update, etc. Note that these various means for invoking or confirming the update installations are meant to be exemplary only, and are not intended to limit the approaches to any particular form, function, or appearance.

As noted above, in some embodiments, the information describing updates includes at least one location from where the updates can be downloaded, e.g., path information, including, e.g., a machine or network address specification. Installing the at least one update of the one or more updates on the computer system may thus include downloading the at least one update from the at least one location. In one embodiment, downloading the at least one update from the at least one location may be performed via HTTP (Hypertext Transfer Protocol), although any other protocol may be used as desired. Note that in various embodiments, the location for downloading the updates may be anywhere on the network. For example, in one embodiment the location may be on the server computer itself. In another embodiment, the location may be one or more third computer systems, e.g., an FTP server. Note that in one embodiment, while the files may be stored on the same servers that host FTP, they may be downloaded via HTTP. Of course in other embodiments, any network accessible device capable of storing and providing the updates for download may be used as desired, and may be transferred via any protocols desired.

### FIG. 5—Flowchart of a Method for Updating Software Over a Network

FIG. 5 illustrates one embodiment of a computer-implemented method for updating software over a network. The method shown in FIG. 5 may be used in conjunction with any of the computer systems shown in the above figures, among other devices. Note that the method of FIG. 5 is from the perspective of a server system. A client side method is described above with reference to FIG. 4. Note further that due to the complementary nature of such client/server approaches, the descriptions and examples of these two methods overlap to some degree. In various embodiments, some of the method elements shown may be performed concurrently, in a different order than shown, or may be omitted. Additional method elements may also be performed as desired. As shown, this method may operate as follows.

First, in 502, a list of the installed software may be received from a client computer system over a network. As noted above with respect to the method of FIG. 4, in preferred embodiments, the list includes the determined unique code and version information for each of one or more programs installed on the (client) computer system. In some embodiments, the list may not include the version information specifically, but this version information may be determinable or derivable from the unique codes. In yet another embodiment the unique code may include the version information. In one exemplary case, the user may be concerned with possible updates to LabVIEW Real-Time 8.6 (provided by National Instruments Corporation), which, for example, may be identified as {AAA-BBB-CCC}, 860, where “{AAA-BBB-CCC}” is the unique code for this software program, and “860” denotes version 8.6.

This list may be received over the network using any network transmission protocols as desired, e.g., HTTP, FTP, email, wireless, etc. In some ways, this list may be considered to be a query by the client to the server for available updates. Thus, from this point of view, one large query regarding updates may be received from the client. This query for updates may include identification of all software for some specified domain installed on the client computer, e.g., all National Instruments Corporation software, etc.

In 504, an update database that stores information regarding the software updates for each of the one or more programs may be queried. As noted above, in some embodiments, the server receives one large query from the client (i.e., the list of 502 and 404 above). In these embodiments, the server may break or parse this query into independent queries—one for each product/version pair. These independent queries may then be sent to the update database, e.g., the update database of FIG. 3.

In 506, information describing updates for at least one of the one or more program may be determined based on the querying of 504. As noted above, in some embodiments, this information may be generated in response to the server making queries to the update database, and may include the responses of each database query, as well as supporting information for each update, including, e.g., location on an FTP server (or other device), description, file size, checksum, and/or conditions to be evaluated prior to displaying the update to the customer/user. The information may be written to a file for transmission to the client system, e.g., an XML file (which is not for display on the client system).

As indicated above with respect to FIG. 4, in some embodiments, the information describing updates may include one or more conditions specifying safety requirements of the one or more updates, where the conditions are useable by the client computer system to determine which of the updates are safe to install on the computer system. The conditions may be specified by a developer, and may be included in the installer for the update (by the developer). Thus, for example, in one embodiment, the server may receive and store an update installer that includes the one or more conditions, and may extract the one or more conditions from the installer, storing the one or more conditions in the database. Subsequently, the server may retrieve the one or more conditions for inclusion in the information describing updates. More specifically, the server may analyze the list of installed software received from the client computer system, and determine respective database queries for each of the one or more programs installed on the client computer system based on this analyzing. As indicated above, querying the database of software updates regarding each of the one or more programs may include independently submitting each of the respective database queries to the database. Of course, in other embodiments, other means for acquiring the conditions may be used as desired.

In 508, the information describing the updates for at least one of the one or more programs may be sent from the server computer system to the client computer system over the network. As noted above, in a preferred embodiment, the information describing updates may be included in an XML (eXtensible Markup Language) file, although any other types of files or formats may be used as desired. As described above, the information describing the updates may be useable by the client system to update (at least one of) the one or more programs installed on the client computer system. The response of the client system to this information is described at length above with reference to FIG. 4.

### Graphical User Interface

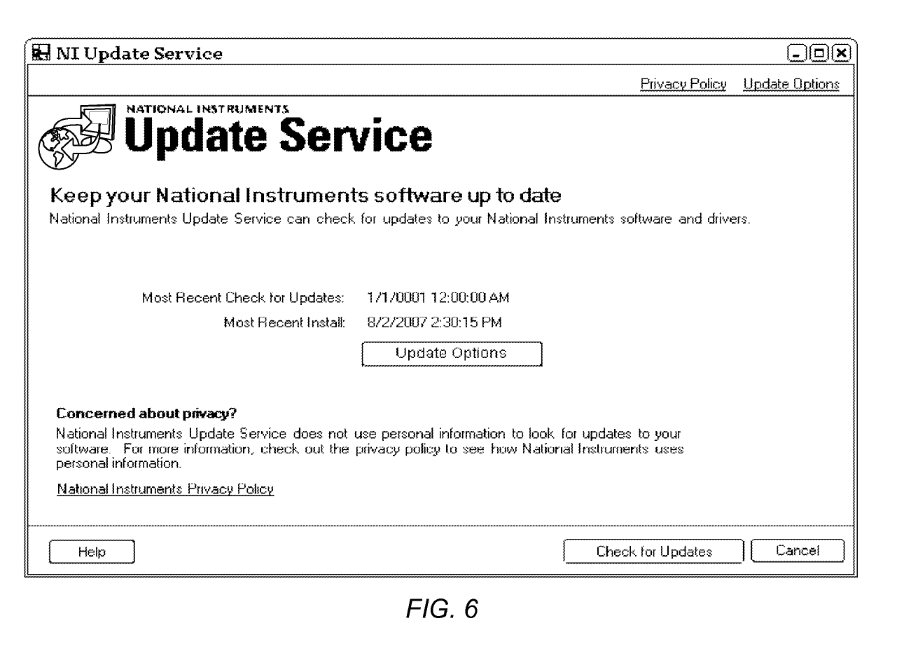

FIGS. 6-8 illustrate exemplary graphical user interfaces (GUIs) for the above-described methods, according to one embodiment. More specifically, FIG. 6 illustrates an exemplary screen shot of an initial screen shown upon launch of the present update service, according to one embodiment. Note that in this embodiment, the update service is specific to software from a particular vendor, in this case, National Instruments Corporation, although it should be noted that in other embodiments the software to be updated may be characterized in other ways, e.g., by application domain, functionality, etc., as desired.

Note further that in the embodiment of FIG. 6, a “Check for Updates” button is provided whereby the user may initiate the update process. As also shown, this GUI also includes an “Update Options” button whereby the user may invoke one or more configuration dialogs for specifying update options. For example, the user may specify certain subsets of the installed software for which to check for updates, although any other kinds of update options may be included as desired.

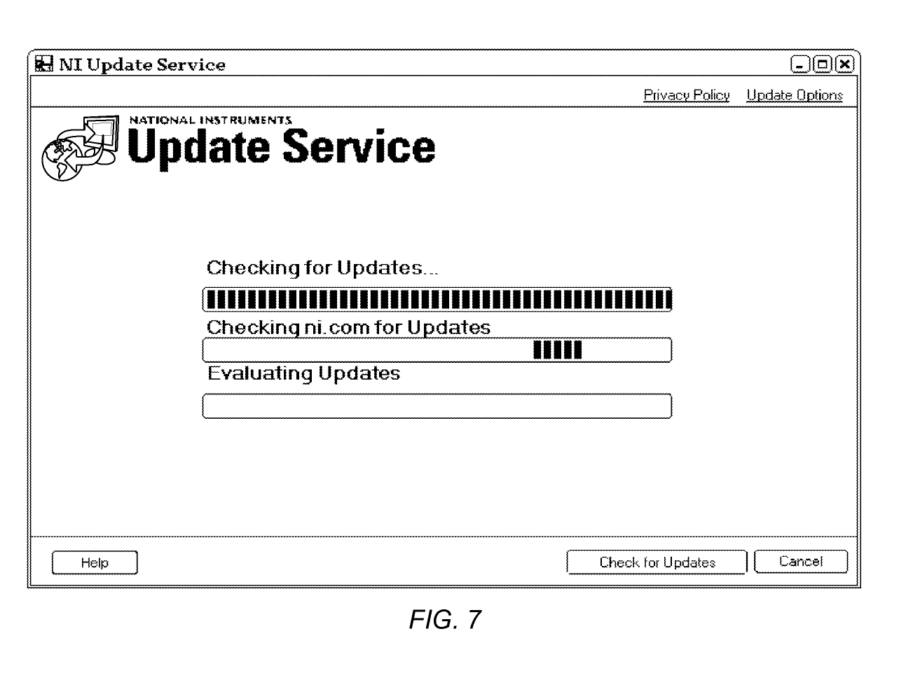

FIG. 7 illustrates an exemplary screen shot of a progress dialog with indicators for displaying progress with regards to various update operations, including, for example, checking for updates, and evaluating the updates, e.g., for safety conditions. Of course, this display is exemplary only, and any other information regarding the updates may be displayed as desired.

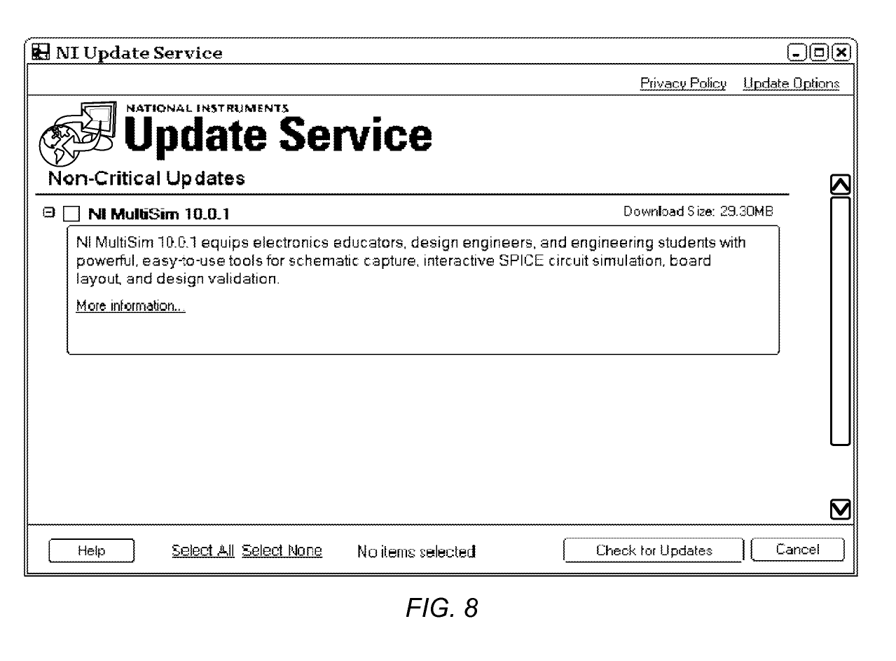

FIG. 8 is an exemplary screen shot of an update dialog listing updates that have been determined to be safe or installation on the client system. In this exemplary embodiment, the update displayed is for a set of software tools, specifically, “NI MultiSim 10.0.1”. Note that the dialog includes a check box next to the update name whereby the user may confirm that the update is to be installed. In some embodiments, if additional updates were found to be safe these updates would also be displayed in the dialog or in subsequent dialogs (or other GUI elements or displays). Note further that in the embodiment shown, the dialog also includes an expansion icon (small “minus” sign to the left of the check box for the update) whereby the user may invoke display of or hide descriptive information regarding the update.

It should be noted that the screen shots shown in FIGS. 6-8 are meant to be exemplary only, and are not intended to limit the GUI to any particular form, function, or appearance.

Thus, various embodiments of the above systems and methods may be used to update software over a network.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer readable memory medium that stores program instructions executable by a processor of a computer system to perform:
scanning the computer system to determine installed software, wherein said determining comprises determining a unique code and version information for each of one or more programs;
generating a list of the installed software in response to said scanning, wherein the list includes the determined unique code and version information for each of the one or more programs;
sending the list to a server computer system over a network;
receiving information describing updates for at least one of the one or more programs from the server computer system over the network;
analyzing the computer system and the information describing updates;
determining one or more updates that are safe to install on the computer system based on said analyzing;
displaying the one or more updates on a display of the computer system; and
installing at least one update of the one or more updates on the computer system.

2. The memory medium of claim 1, wherein said installing at least one update comprises:
automatically installing the one or more updates without direct user input specifying updates to install.

3. The memory medium of claim 1, wherein the program instructions are further executable to perform:
receiving user input confirming the one or more updates;
wherein said installing at least one update comprises:
installing the one or more updates in response to said receiving user input confirming the one or more updates.

4. The memory medium of claim 1, wherein the program instructions are further executable to perform:
receiving user input indicating the at least one update;
wherein said installing at least one update is performed in response to said receiving user input indicating the at least one update.

5. The memory medium of claim 1, wherein the information describing updates comprises at least one location from where the updates can be downloaded, and wherein said installing at least one update of the one or more updates on the computer system comprises downloading the at least one update from the at least one location.

6. The memory medium of claim 5, wherein said downloading the at least one update from the at least one location is performed via HTTP (Hypertext Transfer Protocol).

7. The memory medium of claim 1, wherein the information describing updates comprises one or more of:
file size of each update; or
a checksum for each update.

8. The memory medium of claim 1, wherein the information describing updates comprises one or more conditions specifying safety requirements of the one or more updates, and wherein said analyzing the computer system and the information describing updates comprises analyzing the one or more conditions.

9. The memory medium of claim 8, wherein said analyzing the computer system and the one or more conditions comprises analyzing one or more of:
operating system (OS) of the computer system;
versions of other software installed on the computer system; or
hardware installed in or coupled to the computer system.

10. The memory medium of claim 9, wherein said analyzing the computer system and the one or more conditions comprises:
querying a local database regarding software on the client system; and
the database examining a registry or file system of the client computer system and responding to the query accordingly.

11. The memory medium of claim 1,
wherein said querying a local database regarding software on the client system comprises submitting the one or more conditions to the local database; and
wherein said database responding to the query comprises the database indicating whether the one or more conditions are satisfied.

12. The memory medium of claim 1, wherein the information describing updates is comprised in an XML (eXtensible Markup Language) file.

13. A computer-implemented method, comprising:
scanning the computer system to determine installed software, wherein said determining comprises determining a unique code and version information for each of one or more programs;
generating a list of the installed software in response to said scanning, wherein the list includes the determined unique code and version information for each of the one or more programs;
sending the list to a server computer system over a network;
receiving information describing updates for at least one of the one or more programs from the server computer system over the network;
analyzing the computer system and the information describing updates;
determining one or more updates that are safe to install on the computer system based on said analyzing;
displaying the one or more updates on a display of the computer system; and
installing at least one update of the one or more updates on the computer system.

14. The method of claim 13, wherein the information describing updates comprises one or more conditions specifying safety requirements of the one or more updates, and wherein said analyzing the computer system and the information describing updates comprises analyzing the one or more conditions.

15. The method of claim 14, wherein said analyzing the computer system and the one or more conditions comprises analyzing one or more of:
operating system (OS) of the computer system;
versions of other software installed on the computer system; or
hardware installed in or coupled to the computer system.

16. A computer readable memory medium that stores program instructions executable by a processor of a computer system to perform:
receiving a list of installed software from a client computer system over a network, wherein the list includes a unique code and version information for each of one or more programs installed on the client computer system;
querying an update database regarding each of the one or more programs;
determining information describing updates for at least one of the one or more programs based on said querying;
sending the information describing the updates to the client computer system over the network, wherein the information describing the updates is useable by the client system to update the one or more programs installed on the client computer system.

17. The memory medium of claim 16, wherein the information describing updates comprises at least one location from where the updates can be downloaded.

18. The memory medium of claim 16, wherein the information describing updates comprises one or more of:
file size of each update; or
a checksum for each update.

19. The memory medium of claim 16, wherein the information describing updates comprises one or more conditions specifying safety requirements of the one or more updates, wherein the one or more conditions are useable by the client computer system to determine which of the updates are safe to install on the computer system.

20. The memory medium of claim 19, wherein the program instructions are further executable to perform:
receiving and storing an update installer, wherein the update installer includes the one or more conditions; and
extracting the one or more conditions from the installer; and
storing the one or more conditions in the database; and
retrieving the one or more conditions for inclusion in the information describing updates.

21. The memory medium of claim 16, wherein the program instructions are further executable to perform:
analyzing the list of installed software received from the client computer system; and
determining respective database queries for each of the one or more programs installed on the client computer system based on said analyzing;
wherein said querying the update database regarding each of the one or more programs comprises independently submitting each of the respective database queries to the database.
